(19) United States
(12) Patent Application Publication
(10) Pub. No.: US 2023/0192274 A1
(43) Pub. Date: Jun. 22, 2023

(54) Wingtip

(71) Applicant: Magnus ODDERSHEDE, Bagsvaerd (DK)

(72) Inventor: Magnus ODDERSHEDE, Bagsvaerd (DK)

(21) Appl. No.: 17/770,181

(22) PCT Filed: Oct. 19, 2020
(86) PCT No.: PCT/DK2020/050288

§ 371 Date: Apr. 19, 2022

(51) Int. Cl. B64C 23/06

(52) U.S. Cl. CPC B64C 23/069

(57) ABSTRACT

The component of disadvantageous trailing vortices arising from airflow curling around the tip of an airplane wing can be entirely eliminated by designing a wingtip's sweepback contour such that the local airflow velocity vector just under the leading edge is always directed under the wing.

This application claims priority to US provisional patent application U.S. 62/923,488, filed Oct. 19, 2019, which is hereby incorporated by reference in entirety.

### FIELD

The invention relates generally to wings and rotor blades in which airflows over lift-producing surfaces can give rise to trailing vortices and specifically to a wingtip that eliminates airflow curling around the wingtip and thereby reduces induced drag.

As is well known in the art, a wing with an elliptical lift distribution delivers the highest possible lift with the lowest induced drag. However, elliptical wing planforms are expensive and difficult to manufacture, especially for large commercial aircraft. Accordingly most modern wings feature trapezoidal planforms, which are easier to produce. Wingtips are typically designed as attachments to a trapezoidal wing that improve the wing's overall performance.

Wingtips can be designed so as to optimize a variety of different parameters of wing performance. Many attempts have been made to optimize wingtips in order to generally increase maximum lift at the lowest possible drag. One of the most well-known examples is the winglet—a near-vertical extension of the wing at the wingtip that increases the so-called effective aspect ratio of the wing, which results in decreased induced drag and a higher finite wing lift slope. Compared with increasing the wingspan, a winglet provides some of the benefits without incurring the associated additional cost. Another general aspect of wing performance which some wingtips seeks to improve is to make the lift distribution of a trapezoid planform more closely resemble that of an elliptical one. One such wingtip is the high taper extension of U.S. Pat. No. 5,039,032, in which the leading edge is highly swept in order to shape the planform to more closely replicate the elliptical one, and in order to reduce the total surface area. Another example is the blunt raked wingtip of WO 98/56654, which is a further development of the high taper wingtip in which both the leading- and trailing edges are highly swept, and in which the airfoil varies throughout the wingtip in order to prevent undesirable wing handling characteristics at low magnitudes of freestream velocity.

A more specific aspect of wing performance which some wingtips seek to improve is reducing induced drag arising from the phenomenon of trailing vortices. When moving though an airstream flow, the wing surfaces induce lift by inducing a relatively higher pressure below the wing than above it. In actual practice, notwithstanding the simplistic view in two dimensions, the distribution of lift across a wing span is not linear. Any span-wise change in lift is associated with the shedding of a vortex filament in the flow behind the wing. While some trailing vorticity is inevitable, this problem becomes particularly pronounced to the extent that air moves from higher pressure below the wing to lower pressure above the wing along the lower surface, curling around the tip, which seeds the formation of an actual vortex that is the trailing vortex.

Trailing vortices are disadvantageous not only because the resulting induced drag increases energy consumption but also because they produce a wake region that can be hazardous for other aircraft, especially during takeoff and landing. Accordingly, a large number of different approaches to reducing trailing vortices have been reported through specific wingtip configurations. One such attempt is described in U.S. Pat. No. 4,477,042, wherein the wingtip is rounded at the leading edge and sharp downstream of the wingtip's point of maximum thickness in order to prevent the fluid flow from easily curling around the wingtip and thereby delaying the vortex rollup point. U.S. Pat. No. 4,477,042 further describes a technology that actively discharges fluid from the wingtip in order to disturb the fluid flow at the wingtip so that the radius of the viscous, turbulent core of the vortex increases. Yet other technologies combine different approaches to increasing the efficiency of a wing. For instance, the curved wing tip described in WO 2009/155584 aims to manipulate the planform of the wingtip in order to closely replicate the optimal, elliptic lift distribution as well as delaying vortex rollup. For other examples see e.g., U.S. Pat. Nos. 4,776,542; 5,348,253; 6,722,615; 6,827,314; 6,848,968; US2007/0252031; US2007/0114327; U.S. Pat. Nos. 8,708,286; 9,545,997; US2015/0028160; US2017/233065.

Here we report a novel approach to wingtip design which can be applied to any wing comprising a given planform and airfoil to completely eliminate troublesome curling of airflow around the tip and thereby eliminate vortex-related turbulence on the upper surface of the wing while greatly reducing the energy of trailing vortices. Surprisingly, the component of trailing vortices arising from airflow curling around the tip can be entirely eliminated by designing a wingtip's sweepback contour such that the local airflow velocity vector just under the leading edge is always directed under the wing. The conditions for achieving this effect cannot be defined in simple geometric terms because the local airflow velocity vector is a complex and dynamic variable influenced by many factors including angle-of-attack, dynamic pressure, airfoil, and chord distribution of the wingtip itself and of the wing to which the wingtip is attached. However, for any given wing, one skilled in the art can readily determine a suitable wingtip sweepback contour, without undue experimentation, by applying a simple experimental determination based on techniques routinely applied in the art.

### BRIEF DESCRIPTION OF THE DRAWINGS

FIG. 1 shows a cross section of a generic wing featuring a generic airfoil.

FIG. 2 shows the vortex sheet shed by an airplane featuring a trapezoid wing and the flow induced by the vortex sheet.

FIG. 3 shows a schematic view of a wing with a straight tip as seen from directly below the wing, and an example of the composition of the local flow at a point below the wingtip.

FIG. 4 shows a schematic view of a wing with a Swift Wingtip of the invention as seen from directly below the wingtip, and an example of the composition of the local flow at a point below the wingtip.

FIG. 5 shows the planform of a generic wing and directed line segments of the curve that the leading edge follows at various points on the leading edge.

FIG. 6 shows the streamlines around an airfoil, and the stagnation point.

FIG. 7 shows a photograph of a an example of the wingtip of the invention attached to a trapezoidal wing placed in a wind tunnel with small strings attached to indicate the direction of the local flow at two points.

FIG. 8 shows the local flow velocity vector and directed line segment from the leading edge of the wingtip shown in FIG. 10 of U.S. Pat. No. 4,477,042.

FIG. 9 shows the local flow velocity vector and directed line segment from the leading edge of the wingtip shown in FIG. 2 of US2015/028160.

FIG. 10 shows the local flow velocity vector and directed line segment from the leading edge of the wingtip shown in FIG. 5 of US2017/233065.

FIG. 11 shows the local flow velocity vector and directed line segment from the leading edge of the wingtip shown in FIG. 2B in WO98/56654.

FIG. 12 shows the local flow velocity vector and directed line segment from the leading edge of the wingtip shown in FIG. 4B in WO2009/155585.

FIG. 13 shows a planform view of an embodiment of a wingtip of the invention attached to an unswept wing as seen from directly below the wingtip.

FIG. 14 shows a planform view of an embodiment of the wingtip of the invention attached to an unswept wing that is optimized to lower interference drag as seen from directly below the wingtip.

FIG. 15 shows a planform view of an embodiment of a wingtip of the invention attached to a swept wing as seen from directly below the wingtip.

FIG. 16 shows a planform view of an embodiment of a wingtip of the invention attached to an unswept wing as seen from directly below the wingtip and two sets of directed line segments and freestream velocities.

FIG. 17 shows a planform view of an embodiment of a wingtip of the invention attached to an unswept wing that is optimized to minimize production costs.

FIG. 18 shows an embodiment of a wingtip of the invention attached to a winglet that is attached to a wing.

FIG. 19 shows an example of a wingtip of the invention.

FIG. 20 shows a trapezoidal wing placed in a wind tunnel with a small string attached to indicate the direction of the local flow at a point.

FIG. 21 shows experimentally determined trailing vortex velocities for three different test wings.

### DETAILED DESCRIPTION OF EMBODIMENTS

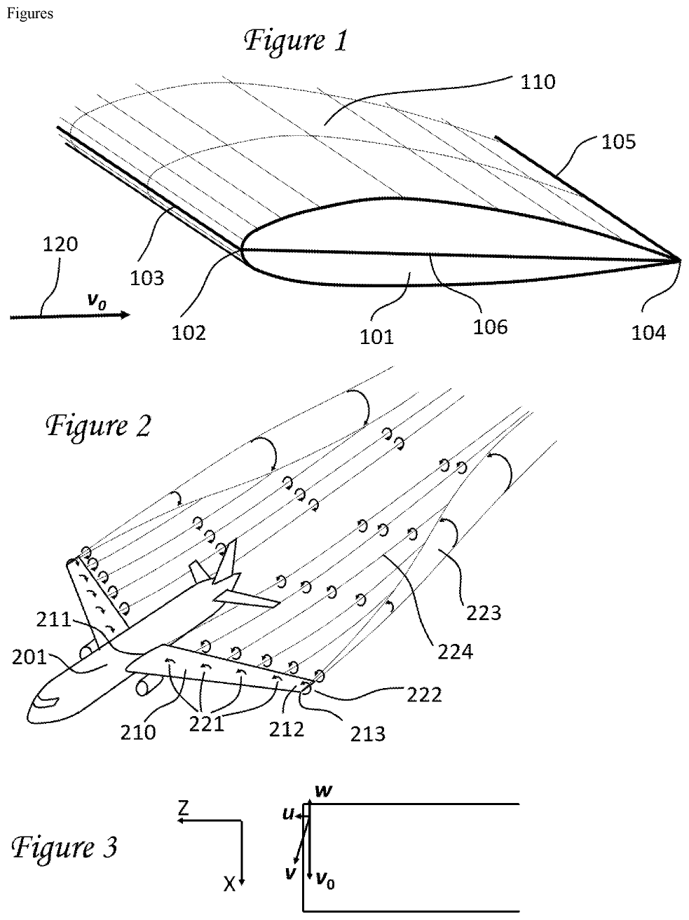

Trailing vortices arise from a complex set of dynamic phenomena. FIG. 1 shows a cross-section of a wing 110 in the XY plane, where the Z axis corresponds to the axis perpendicular to the freestream flow 120 in which the wing extends from an aircraft, and where the X axis is parallel to the freestream flow. The cross section at any given point of the wing is an airfoil, e.g. 101. The foremost point of any given airfoil, e.g. 101, is known as the leading edge point, e.g. 102, while the curve 103 followed by all the leading edge points of all the airfoils used throughout the wing 110 is the leading edge 103 of the wing. The aft most point of any given airfoil, e.g. 101, is known as the trailing edge point, e.g. 104, while the curve 105 followed by all the trailing edge points of all the airfoils used throughout the wing 110 is the trailing edge 105 of the wing. At any given point along the leading edge 103, the straight line 106 that connects the leading edge point 102 and the trailing edge point 104 is known as the chord line. The distance measured along the chord line 106 between the leading edge 103 and the trailing edge 105 at any given point along the leading edge 103 is known as the chord. The angle measured between the freestream flow velocity vector 120 and the chord line 106 is known as the angle of attack. On a given wing, the local airfoil 101 and the thickness as a function of chord length may or may not be constant throughout the span-wise dimension of the wing. Also, the angle of attack may or may not vary throughout the span-wise dimension of the wing. For instance, it is very common to use an airfoil at the wing root that is different from the airfoil near the wingtip, and it is common to twist the wing somewhat down toward the wingtip compared to the wing root so that the angle of attack is greater at the wing root than at the wingtip.

An airfoil produces lift by inducing a clockwise flow (assuming that the airfoil is oriented as in FIG. 1), w=w(x,y), around the airfoil so that the resulting flow around the airfoil is

ν(x,y)=ν₀+w(x,y) (1).

Now, since |w|<|ν₀|, and since the w flow is clockwise, the resulting velocity above the wing is greater than that below the wing. According to Bernoulli's principle,

$$p + \frac{1}{2} ρ {v}^{2} = p + q = constant , \qquad ( 2 )$$

where ν=|ν| is the magnitude of ν, ρ is the density of the air, and q=ρν²/2 is the dynamic pressure, this leads to a relatively lower pressure, p, above the wing and a relatively higher pressure below the wing. This pressure difference results in an upward force (i.e., lift). Due to friction and pressure distributions, the airfoil experiences a force in the X direction, which is equal to the direction of the freestream flow velocity, as well (drag).

According to thin airfoil theory, the lift- and drag per unit span, l and d, respectively, (span being the length of the wing measured in the Z direction) of an airfoil should scale linearly with the freestream dynamic pressure, q₀=ρν₀²/2 and the chord, c:

$$l = {c}_{l} \frac{1}{2} ρ {ν}_{0}^{2} c = {c}_{l} {q}_{0} c , \qquad ( 3 )$$

$$d = {c}_{d} \frac{1}{2} ρ c {ν}_{0}^{2} = {c}_{d} {q}_{0} c , \qquad ( 4 )$$

where the constants cₗ and c_{d} are known as the section lift coefficient and the section drag coefficient, respectively. According to thin airfoil theory, at moderate angles of attack, the section lift coefficient varies linearly with angle of attack, a, until the airfoil stalls:

cₗ=α₀(α−α_{L=0}) (5),

where α_{L=0} is the angle of attack at which the wing produces zero lift and α₀ is a constant known as the 2D lift slope that is determined by the geometry of the airfoil. For a perfect, infinitely thin airfoil placed in a perfect, inviscid flow, α₀=2π.

The airflow around a wing is, however, not constrained to the XY plane of an airfoil but is in fact three-dimensional. In actual practice, there inevitably arise interactions between neighboring sections of a wing such that the lift distribution experiences some span-wise variation. Any span-wise change in lift gives rise to a span-wise change in air circulation, resulting in the shedding into the flow behind the wing of a vortex filament as the lift per unit span decreases toward the wingtip. The vortex filaments shed across the entire span of the wing inevitably give rise to some trailing vorticity that is associated with downward vertical velocity or “downwash” along the entire span of the wing and upward vertical velocity or “upwash” outboard of the wingtips. Of particular importance in amplifying the magnitude of this trailing vorticity is the tendency of air flow at the very tip of the wing to move from higher pressure below the wing to lower pressure above the wing by curling up around the wingtip. The three-dimensional flow velocity at any point (x,y,z) around the wing is determined as

ν(x,y,z)=ν₀+w(x,y,z)+u(x,y,z) (6),

where u(x,y,z) is the velocity in the YZ plane induced by the vortex sheet shed by the wing. FIG. 2 (based on K. De Cleyn, 2011: Forecast based en-route wake turbulence separation, 2011, FIG. 12) illustrates the flow u(x,y,z) from the wing 210 of an airplane 201. The wing 210 sheds infinitesimal vortex filaments such as 224 that combine to form a so-called vortex sheet. As shown, the vortex sheet induces a velocity 221 toward the root 211 of the wing 210 on the upper surface of the wing. Likewise, the vortex sheet induces a velocity toward the wingtip 212 on the lower surface of the wing.

For most current applications of wings, the amount of vortex filaments shed at the wingtip 212 compared to that on the main portion of the wing is so great that practically, the vortex sheet “rolls up” to create an actual vortex that is the trailing vortex 223. As shown, on a normal, trapezoidal wing 210 with a wingtip 212 that largely consists of a straight end that is close to being parallel to the freestream flow velocity, the vortex sheet causes a curling motion 222 of air around the wingtip. Thus, the vortex rollup is seeded by the flow curling around the wing. Ergo, by avoiding flow curling around the wing, the premature formation of a high-energy trailing vortex with a very small vortex core is avoided.

The flow of the rolled up region of the vortex sheet is approximately equal to that induced by a single vortex, which is a circular flow that induces a velocity ν₀ in the YZ plane at a distance r from its center:

$${ν}_{θ} = - \frac{Γ}{2 π r} , \qquad ( 7 )$$

where Γ is the so-called strength of that vortex. Note that in actual practice, this is an approximation that only holds true for R₁<r<R₂, where R₁ is the radius of the vortex core, and R₂ is the radius at which the flow is no longer dominated by the trailing vortex. The core of the vortex is a region of viscous, rather turbulent flow that does not follow the approximation of equation (7). Thus, the energy per unit length of the trailing vortex can be described as the energy per unit length of the trailing vortex within a hollow cylinder of inner radius R₁ and outer radius R₂:

$${E}_{v o r t e x} = {\int }_{{R}_{1}}^{{R}_{2}} 2 π r \frac{1}{2} ρ {ν}_{θ}^{2} d r = \frac{ρ {Γ}^{2}}{4 π} ln \frac{{R}_{2}}{{R}_{1}} . \qquad ( 8 )$$

As stated by equation (8), the energy of the trailing vortex can be decreased by increasing the radius R₁ of the vortex core. On a normal, trapezoidal wing, the vortex rollup begins at the foremost part of the straight end of the wing 213. This causes the trailing vortex to be very stable and have a very small core radius, which means that the energy of the vortex is very high. Since the energy of this vortex can only be supplied by the wing, and since the only way the wing can transfer energy to the surrounding air is mechanically, a force known as induced drag must act on the wing in the opposite direction of the freestream velocity. On a normal passenger jet airplane, induced drag accounts for around 25% of total drag during cruise.

Even with this complicated flow field, the expressions for the total lift and drag forces on a finite wing, L and D, respectively, are similar to those of the lift and drag forces per unit span of an airfoil:

L=C_{L}q₀S (9),

D=C_{D}q₀S (10),

where S is the total wing planform area. Note that the three-dimensional lift- and drag coefficients C_{L} and C_{D} are quite different from cₗ and c_{d} from equations (3) and (4). As with the two-dimensional case, the lift coefficient varies linearly with the angle of attack according to thin airfoil theory until the wing stalls:

C_{L}=α(α−α_{L=0}) (11),

where α is known as the lift slope and is determined by the section lift slope α₀ of the airfoil used in the wing, the Mach number, M, at which the wing operates, which is the ratio between the freestream velocity and the speed of sound of the flow, and the planform of the wing. For a wing with an elliptic lift distribution and a constant sweep angle A, according to lifting line theory,

$$a = \frac{{a}_{0} cos Λ}{\sqrt{1 - {M}^{2} {cos}^{2} Λ + {( \frac{{a}_{0} cos Λ}{π A R} )}^{2}} + \frac{{a}_{0} cos Λ}{π A R}} , \qquad ( 12 )$$

where AR is the aspect ratio of the wing, which is defined as

$$A R = \frac{{b}^{2}}{S} , \qquad ( 13 )$$

where b is the wingspan of the wing, which is the distance measured along a straight line from one wingtip to the other. For all other lift distributions than the elliptic one the lift slope is lower than the one stated above: α_{elliptic}≥α. A wing having an elliptical lift distribution means that the lift per unit span, L′, varies elliptically from one wingtip to the other. That is,

$${L}^{′} ( z ) = {L}_{0}^{′} \sqrt{1 - {( \frac{z}{b} )}^{2}} \qquad ( 14 )$$

According to lifting line theory, a wing with an elliptical lift distribution produces a vortex sheet that is shaped so that the downwash is uniform, which minimizes induced drag. Practically, an elliptical lift distribution is achieved if the wing planform is elliptic. However, lifting line theory disregards the viscous, turbulent core of the trailing vortex. Thus, even for a wing with an elliptical lift distribution, induced drag can be reduced by increasing the radius of the vortex core.

For a trapezoidal wing, induced drag can be reduced to levels approaching those produced by an optimal, elliptical wing by eliminating the airflow curling around the wingtip from its lower surface to its upper surface. This effect can be achieved through application of a wingtip of the invention. The curling airflow around the wingtip depends in part on the local airflow in the YZ plane at the tip, velocity u=u(x,y,z). At a given point P in any fluid flow, an actual flow velocity can be measured. Since the velocity of the flow varies in space, the flow velocity at a specific point P is a resultant vector, known as the local flow velocity, ν, at P. This is influenced by various components including the dynamic pressure, q₀, the angle of attack, a, the turbulence of the flow, the geometry of the airfoil, the planform of the wing and of course by the related value of the local velocity vector u. The magnitude, ν, of the local flow velocity vector, or length, |ν|, of ν is equal to the local flow speed at P. The direction of ν is the direction of the flow at P. The local flow velocity vector ν at any given point is very difficult to model based solely upon the geometric features of the wing and airfoils in question. It is, however, possible to experimentally determine the direction of the local velocity vector ν at various points along the edges of wingtips using comparatively simple techniques well known and widely used in the art.

Through a combination of consideration of wingtip geometry and experimental determination it is possible, without undue experimentation, to arrive at a wingtip of the invention that eliminates airflow curling around the wingtip.

On a standard trapezoidal wing without modification, the tip consists of a largely straight end that is parallel to the freestream flow velocity as shown in FIG. 3. At any given point, the local flow velocity vector in the plane of the wing (the XZ-plane) is the resultant of ν₀, u, and w. Due to the u component, the resulting flow velocity ν below the lower surface of the wing is directed outward beyond the wingtip. This leads to the flow curling around the wingtip and the associated problems of vortex turbulence above the wing and amplification of trailing vortices.

On a wing fitted with a wingtip of the invention, the leading edge sweeps back to meet the trailing edge as shown schematically for one embodiment in FIG. 4. In designing a wingtip of the invention, the contour of this sweepback is determined for any given wing so that over the entire course of all swept portions of the wingtip's leading edge, it is angled outward at a greater angle than the resulting local flow velocity vector ν under tested experimental conditions covering a range of angles of attack and dynamic pressures. In this case, the flow does not curl around the wingtip at any point or under any condition. This has the advantage of eliminating vortex-related turbulence on the upper surface of the wing and leads to a substantial reduction in the energy of trailing vortices.

In some embodiments, the invention provides a wingtip having a leading edge and a trailing edge and being associated with a main wing characterized in that:
its' leading edge sweeps back from the leading edge of the main wing until it reaches its' trailing edge, and
its' leading edge follows a curve, S, the contour of which is configured such that, for the range of angle of attack between 0° and 2°, and for the range of dynamic pressure between 10 kPa to 12 kPa, at every point along the course of all swept portions of the wingtip's leading edge, the local flow velocity vector, ν, at 10% of the local chord aft of the leading edge forms an angle θ with a directed line segment dS extended from S, which angle is greater than 0° and less than 180°, where θ is measured in the outboard rotational direction from ν to dS,

wherein in the case of rear swept portions of the wingtip's leading edge, the directed line segment dS is extended in the aft direction, and wherein in the case of forward swept portions of the wingtip's leading edge, the directed line segment is extended in the forward direction.

It will be readily understood by one skilled in the art that the point at which ν is measured is located directly aft of the point at which dS is determined.

As used herein, the following terms have the following meanings:

“Wingtip” refers to the portion of a wing corresponding to the outboard 10% of its span. A wingtip may be configured either as a separate component that is attached to a main wing or as a shape embodied by a wing. “Main wing” refers to the portion of a wing corresponding to the inboard 90% of its span.

As used herein, the following terms have the following meanings:

“Leading edge” refers to the surface defining the foremost edge of an airfoil and may include one or more sections that are largely parallel to the freestream flow velocity as well as one or more sections that stretch rearward to meet the trailing edge, except that protrusions in general that are not primarily intended to improve wing performance and in particular corresponding to high-lift devices such as leading edge root extensions, dog teeth, leading edge cuffs, slots and the like; and retractable high-lift devices such as slats, Krueger flaps, droop flaps, and similar devices, when in the deployed position; and other retractable protrusions such as de-icing boots when deployed; and fixed protrusions such as pitot tubes, pylons for engines, armaments, or other equipment, wing fences, gun barrels, antennas, lightning rods, flap fairings, housing for equipment such as lights, radar domes and other equipment; and moveable surfaces such as control surfaces when not in their neutral position are not to be considered part of the “leading edge” within the meaning of the claims.

“Trailing edge” refers to the surface defining the rearmost edge of an airfoil, except that protrusions in general that are not primarily intended to improve wing performance and in particular corresponding to retractable high-lift devices such as different kinds of trailing edge flaps when deployed; and fixed protrusions such as pylons for engines, armaments, or other equipment, wing fences, gun barrels, antennas, lightning rods, flap fairings, housing for equipment such as lights, radar domes and other equipment, crop dusting equipment, and similar devices; and moveable surfaces such as control surfaces when not in their neutral position are not to be considered part of the “trailing edge” within the meaning of the claims.

“Swept portion of the leading edge” refers to any portion of the leading edge over which the leading edge stretches forward or aft. “Swept portion” may be either straight or curved. Straight portions of swept portions of the leading edge are characterized in having a “swep angle,” which refers to the angle between the leading edge and the YZ plane, i.e. the angle between the leading edge and the plane that is perpendicular to the freestream velocity. This means that a straight portion of a swept portion of a leading edge has a constant sweep angle. For curved portions of swept portions of the leading edge, there is no constant sweep angle. The term “unswept” refers to the case where a portion of the leading edge is displaced neither forward nor aft and is perpendicular to the freestream velocity, with a sweep angle of 0.° “All swept portions of the leading edge” refers to all sections of the leading edge that are swept as described above.

“Curve S” refers to the contour of the leading edge which may include linear and/or curvilinear sections.

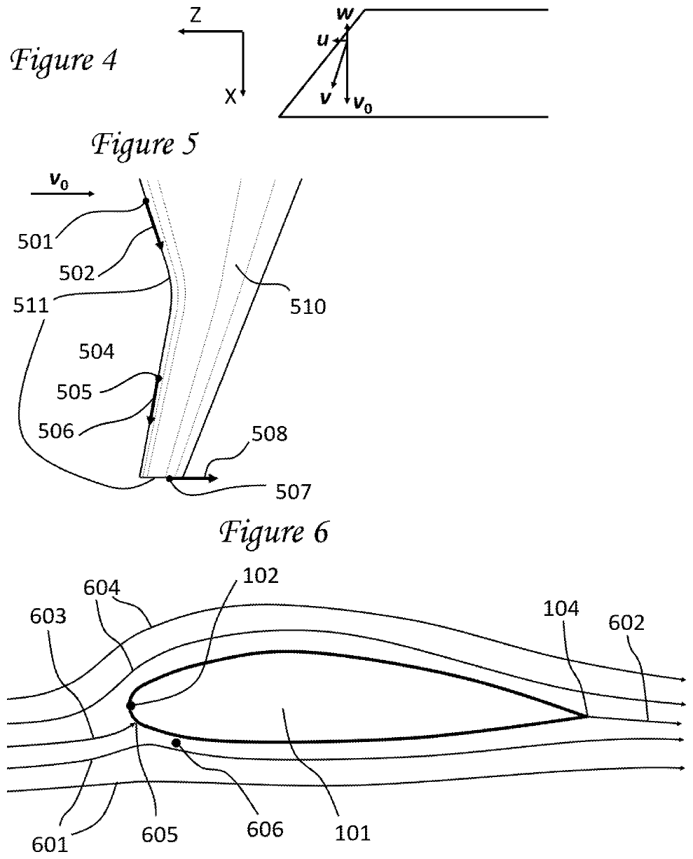

“Directed line segment, dS” refers to a line segment that is determined at any point along the contour of the leading edge S that is parallel to the curve S that the leading edge follows at the point in which the directed line segment dS is evaluated and that points in the aft direction, in the case of a rear-swept portion of the leading edge, or in the forward direction, in the case of forward-swept portions of the leading edge. Examples of directed line segments are shown in FIG. 5. For a generic wing 510, the leading edge 511 follows a curve S that is curved in some places and straight in other places, swept forward in some places, unswept in some places, and swept rearward in some places. At any point along S, the directed line segment can be determined. On a section where the leading edge is straight and rear swept, the directed line segment 502 is shown at a point 501. On a section where the leading edge is straight and swept forward, the directed line segment 506 is shown at a point 505. On a section of the leading edge that is largely parallel to the freestream flow velocity and stretches rearward to meet the trailing edge, the directed line segment 508 is shown at a point 507.

“Local flow velocity vector, ν, at 10% of the local chord aft of the leading edge” refers to the local flow velocity vector, the direction of which is the direction of the air flow, at a point that is a distance aft of the leading edge corresponding to 10% of the length of the chord corresponding to the chord line on which the point is situated. FIG. 6 shows an illustration of the point at which the local velocity vector is determined, referring to the same airfoil 101 as shown in FIG. 1 with a leading edge point 102. Around the airfoil 101, streamlines are shown that illustrate the paths in which air particles move in the XY plane when travelling around the airfoil. Two streamlines 601 are shown below the airfoil, and two streamlines 604 are shown above the airfoil. One streamline 603 hits the airfoil at a point 605 instead of going above the airfoil or below the airfoil. This point 605 is known as the stagnation point and is the point that separates streamlines going above the airfoil from streamlines going below the airfoil. The equivalent continuation 602 of the streamline 603 behind the airfoil emerges from the trailing edge 104. The point 606 corresponds to a point just below the lower surface of the wing that is located 10% of the local chord aft of the leading edge point 102. This location, which is behind the stagnation point for most airfoils at most angles of attack and at most dynamic pressures, corresponds to a preferred location for experimental measurement of the angle θ between the local flow velocity vector, ν, and the directed line segment dS extended from S.

Within the meaning of the claims herein, one skilled in the art can experimentally confirm that the contour of the leading edge curve S “is configured such that at every point along the course of all swept portions of the wingtip's leading edge, the local flow velocity vector, ν, at 10% of the local chord aft of the leading edge forms an angle θ with a directed line segment dS extended from S, which angle is greater than 0° and less than 180°, where θ is measured in the outboard rotational direction from ν to dS” as follows: Prepare a scale model by 3D printing of the proposed wingtip attached to a wing for which the wingtip is intended to be applied using a process that provides accuracy at least 50 μm with nozzle head not greater than 0.4 mm. Sand the surfaces of the model wing with fine sand paper having at least 600 grit then paint the sanded surface using blank paint for a smooth finish—preferably spray paint. Attach to the high pressure side of the scale model wing at locations 10% of the local chord aft of all swept portions of the leading edge pieces of string having length of at least 1 cm and preferably no longer than 50% of the local chord using tape with the following placements: (a) For straight portions of any swept portions of the leading edge, for each section having a different sweep angle, attach strings at three points corresponding to a foremost point, a rearmost point, and a point equidistant between the two; (b) for curved portions of any swept portions of the leading edge, attach strings at the foremost part of the curve, the rearmost part of the curve, and either one point equidistant between the two or, if applicable, one point for every 5° of curvature between; (c) except that in the particular case of the rearmost point on the leading edge, closest to the trailing edge, whether located on a straight or curved section, the measurement is made at a position that is forward from the point at which the leading edge meets the trailing edge by a distance corresponding to 1% of the local chord at the point at which the wingtip connects to the main wing.

Place the model wing with strings attached in a wind tunnel and apply desired conditions of dynamic pressure and angle of attack. For each point at which strings are attached, the direction of the local flow velocity vector ν is indicated by the direction in which the string points at the point where it is released from the attaching tape. To the extent that no string at any of the designated points of attachment points in a direction leading over the edge of the leading edge, then the contour of the leading edge curve S “is configured such that at every point along the course of all swept portions of the wingtip's leading edge, the local flow velocity vector, ν, at 10% of the local chord aft of the leading edge forms an angle θ with a directed line segment dS extended from S, which angle is greater than 0° and less than 180°, where θ is measured in the outboard rotational direction from ν to dS” within the meaning of the claims herein.

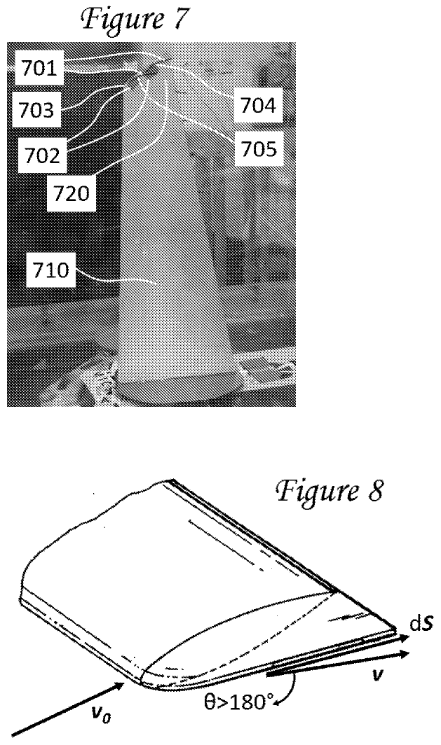

Measurement of the angle θ at a definite point 10% of the local chord aft of the leading edge along the course of the swept portion of the leading edge is illustrated in FIG. 7, which shows a photograph of a wing 710 comprising an embodiment of a wingtip of the invention 720 placed in a wind tunnel. The photograph is oriented so that the lower (high pressure) surface of the wing 710 and wingtip 720 is shown. In this photograph, the wing is placed in a flow of 50 m/s at an angle of attack of 6°. At a point 704 located 15% of the local chord aft of the leading edge 703 and at a point 705 located 10% of the local chord aft of the leading edge 703, small strings 701 are attached to the surface of the wingtip 720 using tape 702. The direction in which the strings 701 point at the point at which they are released from the tape is equal to the direction of the local flow velocity, ν. From this analysis, the direction of the local flow velocity at the points 704 and 705 where the strings 701 are released from the tape 702 can be determined by determining the direction of the strings immediately after the strings have been released. Analysis of the photograph shows that at point 705, θ=27°, and at point 704, θ=22°.

In some embodiments, the invention provides a wingtip having a leading edge and a trailing edge and being associated with a main wing characterized in that:
its' leading edge sweeps back from the leading edge of the main wing until it reaches its' trailing edge, and
its' leading edge follows a curve, S, the contour of which is configured such that, for the range of angle of attack between 0° and 2°, and for the range of dynamic pressure between 10 kPa to 12 kPa, the local flow velocity vector, ν, at 10% of the local chord aft of the leading edge forms an angle θ with a directed line segment dS extended from S, which angle is greater than 0° and less than 180°, where θ is measured in the outboard rotational direction from ν to dS, at each of the following points: (a) For straight portions of any swept portions of the leading edge, for each section having a different sweep angle, at three points corresponding to a foremost point, a rearmost point, and a point equidistant between the two; (b) for curved portions of any swept portions of the leading edge, at at least three points corresponding to the rearmost part of the curve, and either one point equidistant between the two or, if applicable, one point for every 5° of curvature between; (c) except that in the particular case of the rearmost point on the leading edge, closest to the trailing edge, whether located on a straight or curved section, the measurement is made at a position that is forward from the point at which the leading edge meets the trailing edge by a distance corresponding to 1% of the local chord at the point at which the wingtip connects to the main wing,

wherein in the case of rear swept portions of the wingtip's leading edge, the directed line segment dS is extended in the aft direction, and wherein in the case of forward swept portions of the wingtip's leading edge, the directed line segment is extended in the forward direction.

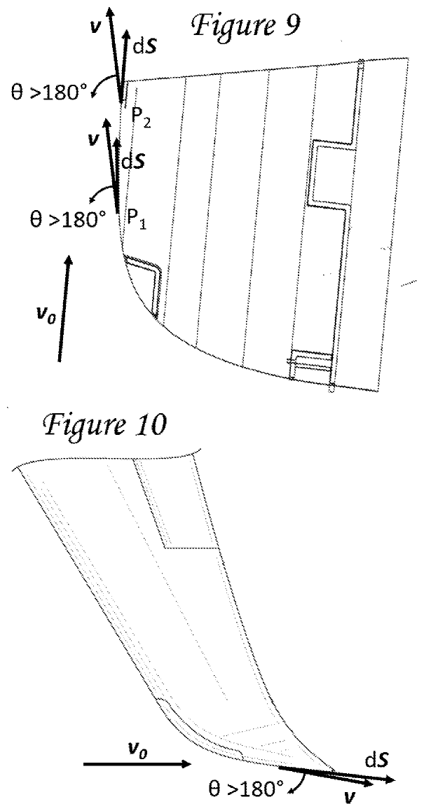

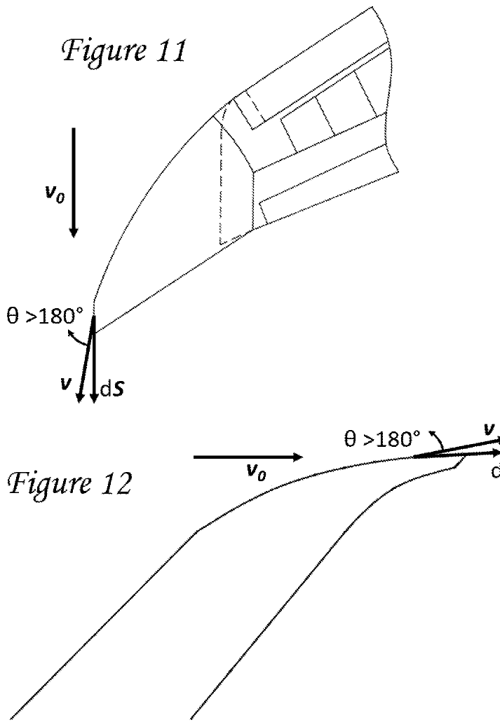

One skilled in the art will readily arrive at a wingtip of the invention suitable for use with any given wing. A first estimate of an appropriate wingtip geometry can be made based on an assumption that the airfoil of the attached wing and other dynamic variables have no effect on local flow velocity vector over the swept portion of the wingtip's leading edge. For example, such a first assessment is shown in FIG. 8 for the wingtip shown in FIG. 10 of U.S. Pat. No. 4,477,042; in FIG. 9 for the wingtip shown in FIG. 2 of US2015/028160; in FIG. 10 for the wingtip shown in FIG. 5 of US2017/233065; in FIG. 11 for the wingtip shown in FIG. 2B of WO98/56654; and in FIG. 12 for the wingtip shown in FIG. 4A of WO2009/155584. In each of the FIGS. 8 through 12, ν₀ refers to freestream velocity vector, ν refers to the local flow velocity vector, dS is directed line segment, and θ is the angle between ν and dS measured in the outboard rotational direction. As shown in every case, to a first approximation assuming no effects of airfoil or other dynamic variables, the original wingtip design will not satisfy the desired criteria.

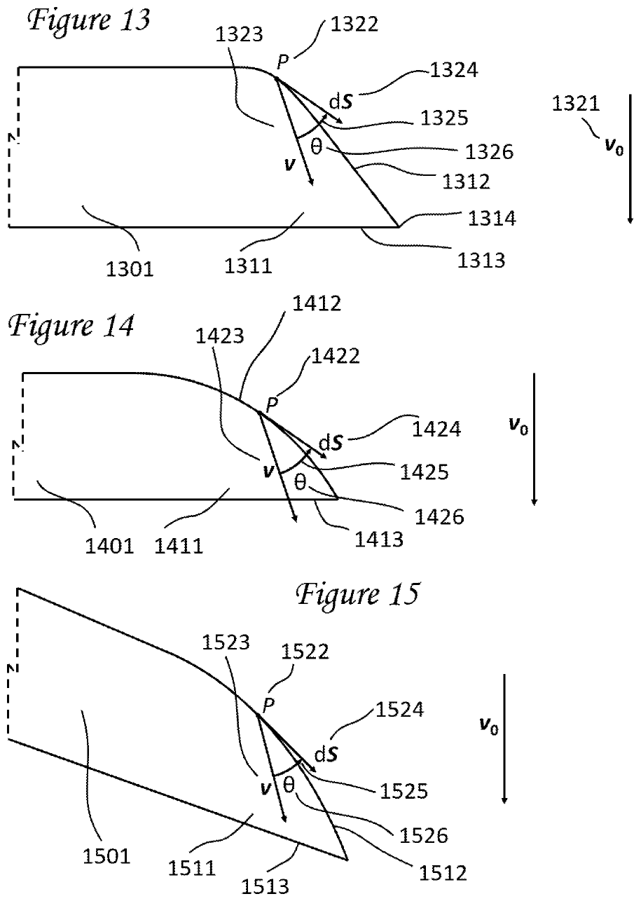

FIGS. 13-18 show examples of schematic drawings of wingtip geometries that do satisfy the desired criteria in a first approximation. FIG. 13 shows a close-up profile view of a wingtip 1311 mounted on an unswept wing (a wing that extends perpendicularly to the incoming flow) 1301 as seen from directly below the wingtip. The freestream incoming flow velocity is represented by the vector ν₀ 1321. At a point, P, 1322 along the leading edge, the local flow velocity at a point 10% of the local chord aft of the leading edge is represented by the vector, ν, 1323. The leading edge 1312 follows a curve, S. The directed line segment in the aft direction of the leading edge curve S is known as dS, 1324 where shown at P 1322. The angle between the local flow velocity, ν, 1323 and the directed line segment, dS, 1324 measured in the rotational direction indicated by the arrow 1325 is known as θ 1326. As shown, to a first approximation, assuming no airfoil or other dynamic variable effects, for all points P along all swept portions of the leading edge 1312, the angle, θ, 1326 between the local flow velocity vector, ν, 1323 and the directed line segment in the outboard direction of the leading edge curve S, dS, 224 as measured in the rotational direction indicated by the arrow 1325 is greater than zero and less than 180° until reaching the trailing edge 1313. The trailing edge 1313 may follow any curve until reaching the leading edge 1312 in a point 1314. For all FIGS. 13-18, the location of point P as shown appears closer to the leading edge than a distance aft corresponding to 10% of the local chord.

FIG. 14 shows a similar profile of a wingtip 1411 attached to an unswept wing 1401 as seen from directly below the wingtip. In this case the leading edge 1412 follows a rounded curve rather than a straight line. As shown, to a first approximation, assuming no airfoil or other dynamic variable effects, for all points P such as 1422 along all swept portions of the leading edge 1412, the angle, θ, 1426 between the local flow velocity vector at a point 10% of the local chord aft of the leading edge, ν, 1423 and the directed line segment in the aft direction of the leading edge curve S, dS, 1424 as measured in the rotational direction indicated by the arrow 1425 is greater than zero and less than 180° until reaching the trailing edge 1413.

FIG. 15 shows a wingtip 1511 attached to a swept wing 1501 as seen from directly below the wingtip. As shown, to a first approximation, assuming no airfoil or other dynamic variable effects, for all points P such as 1522 along all swept portions of the leading edge 1512, the angle, θ, 1526 between the local flow velocity vector at a point 10% of the local chord aft of the leading edge, ν, 1523 and the directed line segment in the aft direction of the leading edge curve S, dS, 1524 as measured in the rotational direction indicated by the arrow 1525 is greater than zero and less than 180° until reaching the trailing edge 1513.

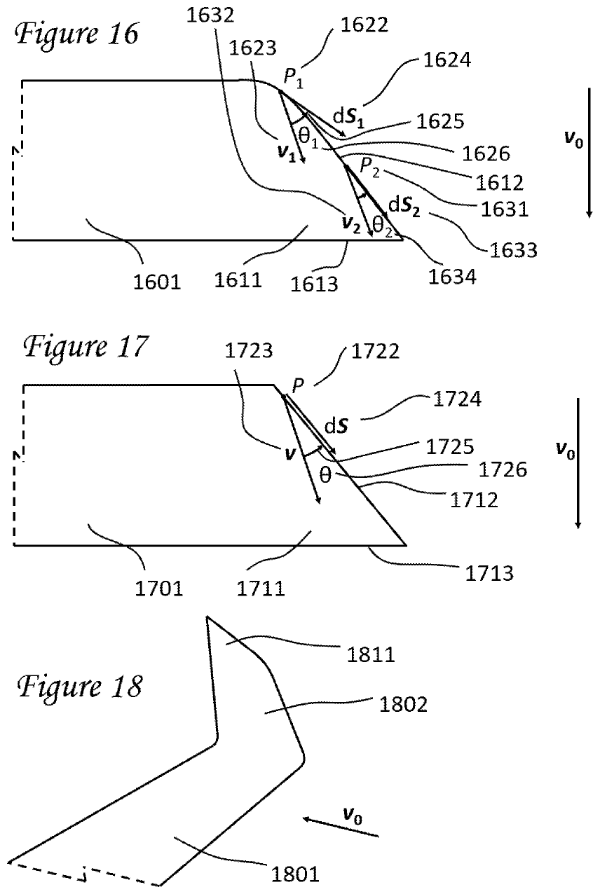

FIG. 16 shows a wingtip 1611 attached to an unswept wing 1601. Two points, P₁ 1622 and P₂ 1631, along the leading edge 1612 are highlighted. The angle between the local flow velocity vector at a point 10% of the local chord aft of the leading edge, vi, 1623 and the directed line segment in the aft direction of the leading edge curve S, dS₁, 1624 in the rotational direction indicated by the arrow 1625 at P₁ 1622 is known as θ₁ 1626. The corresponding angle between the local flow velocity vector at a point 10% of the local chord aft of the leading edge, ν₂, 1632 and the directed line segment in the aft direction of the leading edge curve S, dS₂, 1633 at P₂ 1631 is known as θ₂ 1634. In this case, there are infinitely many points Pₙ along the leading edge 1612. Each point Pₙ along the leading edge 1612 has a certain value of the angle θₙ between the local flow velocity vector at a point 10% of the local chord aft of the leading edge and the directed line segment. Therefore, the above described angle θ is a function of the position on the leading edge curve S and can be written as θ(S). In this embodiment, θ₁=θ(P₁) 1626 is not equal to θ₂=θ(P₂) 1634, which means that the angle, θ, between the local flow velocity vector at a point 10% of the local chord aft of the leading edge, ν, and the directed line segment, dS, varies along the curve, S, that the leading edge 1612 follows. In other words, θ(S) is not a constant function in this case. Nevertheless, as shown, to a first approximation, assuming no airfoil or other dynamic variable effects, for all points P along all swept portions of the leading edge 1612, the angle, θ between the local flow velocity vector at a point 10% of the local chord aft of the leading edge, ν, and the directed line segment in the aft direction of the leading edge curve S, dS, as measured in the rotational direction indicated by the arrow 1625 is greater than zero and less than 180° until reaching the trailing edge 1613.

FIG. 17 shows a wingtip 1711 attached to an unswept wing 1701 where the design is optimized to lower production costs. The leading edge 1712 follows a straight line until reaching the trailing edge 1713. Designing and manufacturing such a simple structure is typically easier and less expensive than designing and manufacturing more complex, curved structures. As shown, to a first approximation, assuming no airfoil or other dynamic variable effects, for all points P such as 1722 along all swept portions of the leading edge 1712, the angle, θ, 1726 between the local flow velocity vector at a point 10% of the local chord aft of the leading, ν, 1723 and the directed line segment in the aft direction of the leading edge curve S, dS, 1724 as measured in the rotational direction indicated by the arrow 1725 is greater than zero and less than 180° until reaching the trailing edge 1713.

FIG. 18 shows a wingtip 1811 attached to a winglet 1802 which is in turn attached to a swept wing 1801. The wingtip 1811 does not significantly depart from the plane of the winglet 1802.

Once a wingtip geometry that satisfies the desired criteria to a first approximation has been determined, a scale model of the wingtip attached to the desired wing with desired airfoil can be tested in a wind tunnel as described previously. These experimental tests can determine the actual alignment of the local velocity vector at specified points 10% of the local chord aft of the leading edge over all swept portions of the leading edge over a range of dynamic conditions including angles of attack and dynamic pressures typically encountered during takeoff, cruise and landing. Typical angles of attack at takeoff, cruise and landing vary from −10° to +26°, or from −8° to +23°, or from −6° to +20°, or from −4° to +18°, or from −2° to +16°, or from 0° to +14°, or from +1° to +12°, or from +2° to +10, or from +3° to +9°, or from +4° to +8°, or from +5° to +7°, or from +6° to +11°, or from +7° to +13°, or from +8° to +15°, or from +9° to +17°, or from +10° to +19°, or from −10° to −6°, or from −9° to −4°, or from −7° to −2°, or from −5° to 0°, or from −3° to +1°, or from −1° to +1°, or from 0° to +2°, or from 0° to +3°, or from 0° to +4°, or from 0° to +5°, or from 0° to +6°. Typical dynamic pressures encountered during takeoff, cruise and landing vary from 250 Pa to 4200 Pa, or from 2700 Pa to 16 kPa, or from 2700 Pa to 25 kPa, or from 1300 Pa or to 8 kPa, or from 0 Pa to 1590 Pa, or from 0 Pa to 1550 Pa, or from 0 Pa to 1.5 MPa, or from 3.7 kPa to 10.2 kPa, or from 200 Pa to 19.5 kPa, or from 2 kPa to 9.8 kPa. To the extent that dynamic conditions are identified in which the desired criteria are not satisfied, the design can be modified and the testing process repeated.

As will be readily apparent to one skilled in the art, a large number of different configurations can be applied to provide a wingtip of the invention. A wingtip of the invention can be based on any planform and any suitable airfoil or plurality of airfoils with or without span-wise camber or twist, including but not limited to any airfoil listed in the UIUC Airfoil Coordinates Database: (as recorded Oct. 19, 2020 at https://m-selig.ae.iilinois.edu/ads/coord_database.html).

In some embodiments, a wingtip of the invention is configured such that it its' leading edge follows a curve, S, the contour of which is configured such that it does not exhibit the performance characteristics of a delta wing, at any angle of attack within the range −5° to +15°, or from −10° to +26°, or from −8° to +23°, or from −6° to +20°, or from −4° to +18°, or from −2° to +16°, or from 0° to +14°, or from +1° to +12°, or from +2° to +10, or from +3° to +9°, or from +4° to +8°, or from +5° to +7°, or from +6° to +11°, or from +7° to +13°, or from +8° to +15°, or from +9° to +17°, or from +10° to +19°, or from −10° to −6°, or from −9° to −4°, or from −7° to −2°, or from −5° to 0°, or from −3° to +1°, or from −1° to +1°, or from 0° to +2°, or from 0° to +3°, or from 0° to +4°, or from 0° to +5°, or from 0° to +6° or at any dynamic pressure within the range from 240 Pa to 25 MPa, or from 250 Pa to 4200 Pa, or from 2700 Pa to 16 kPa, or from 2700 Pa to 25 kPa, or from 1300 Pa or to 8 kPa, or from 0 Pa to 1590 Pa, or from 0 Pa to 1550 Pa, or from 0 Pa to 1.5 MPa, or from 3.7 kPa to 10.2 kPa, or from 200 Pa to 19.5 kPa, or from 2 kPa to 9.8 kPa. It will be appreciated by those skilled in the art that performance characteristics of a delta wing are that the lift on the wing is induced by a leading edge vortex on the upper surface of the wing. In some embodiments, a wingtip of the invention may feature a transitioning area characterized in that it includes an aerodynamic fairing such as a curve that forms a smooth transition from the leading edge of the main wing to the leading edge of the wingtip.

In some embodiments, a wingtip of the invention has a transitioning area characterized in that it has a leading edge in the transitioning area that is curved, in general, or specifically elliptical over a span that is at least 25% of the span from the point of attachment at the leading edge of the wing to which the wingtip or other wingtip to which the wingtip is attached is attached to the point where the wingtip of the invention's leading edge meets its' trailing edge.

In some embodiments, a wingtip of the invention is configured such that the local flow velocity vector, ν, at a point 10% of the local chord aft of the leading edge forms an angle θ with a directed line segment dS extended from S which angle is greater than 0° and less than 180°, where θ is measured in the outboard rotational direction from ν to dS, for selected points along swept portions of the leading edge at any angle of attack within the range from −5° to +15°, or from −10° to +26°, or from −8° to +23°, or from −6° to +20°, or from −4° to +18°, or from −2° to +16°, or from 0° to +14°, or from +1° to +12°, or from +2° to +10, or from +3° to +9°, or from +4° to +8°, or from +5° to +7°, or from +6° to +11°, or from +7° to +13°, or from +8° to +15°, or from +9° to +17°, or from +10° to +19°, or from −10° to −6°, or from −9° to −4°, or from −7° to −2°, or from −5° to 0°, or from −3° to +1°, or from −1° to +1°, or from 0° to +2°, or from 0° to +3°, or from 0° to +4°, or from 0° to +5°, or from 0° to +6° or at any dynamic pressure within the range from 240 Pa to 25 MPa, or from 250 Pa to 4200 Pa, or from 2700 Pa to 16 kPa, or from 2700 Pa to 25 kPa, or from 1300 Pa or to 8 kPa, or from 0 Pa to 1590 Pa, or from 0 Pa to 1550 Pa, or from 0 Pa to 1.5 MPa, or from 3.7 kPa to 10.2 kPa, or from 200 Pa to 19.5 kPa, or from 2 kPa to 9.8 kPa.

In some embodiments, a wingtip of the invention has a constant, cambered, not flat, cross-sectional airfoil. In some embodiments, a wingtip of the invention has a constant maximum thickness as a percentage of chord length between 8 and 15%. In some embodiments, a wingtip of the invention has a rounded leading edge in which the leading edge is not tapered to a point.

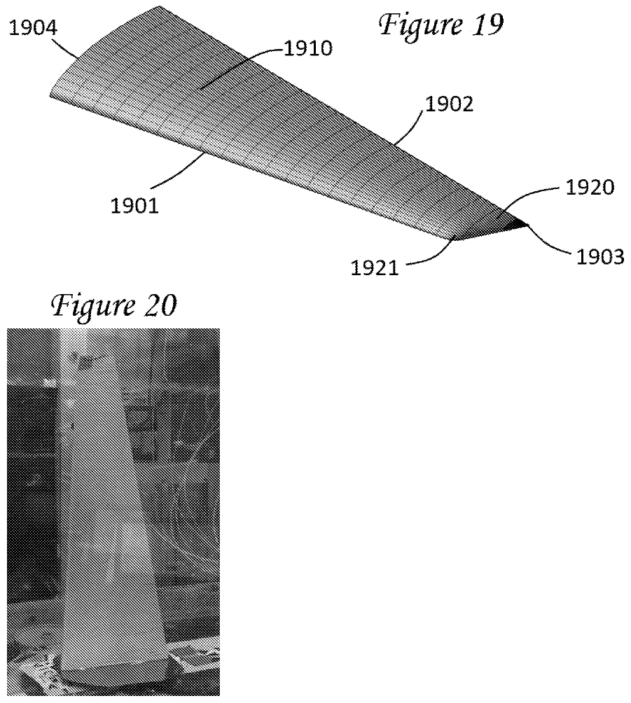

One example of a wing with an airfoil and an outboard section featuring a wingtip of the invention which satisfies the above mentioned desired condition over the entire range of angle of attack from −5° to +15° and over the entire range of dynamic pressure from 240 Pa to 25 kPa is shown in FIG. 19. A scale model of the wing 1910 fitted with this embodiment of a wingtip of the invention 1920 was prepared and tested in a wind tunnel as described in Examples 1 and 2.

FIG. 19 shows a wing 1910 that features a Swift Wingtip 1920. The Swift Wingtip 1920 features a transitioning area 1921 that connects the wingtip 1920 to the main wing 1910. The wing features a leading edge 1901 that runs throughout the length of the wing 1910, through the transitioning area 1921, and through the Swift Wingtip 1920 until meeting the trailing edge 1902 at the outboard tip 1903 if the Swift Wingtip.

The airfoils of the wing 1910 and of the wingtip of the invention 1920 including the transitioning area 1921 are all NACA 4412 applied as a constant airfoil. As dictated by the constant airfoil, the ratio between the local maximum thickness and the local chord at any spanwise location is a constant 12%, which is a feature of the NACA 4412 airfoil. The chord, c, varies throughout the wing as a function of the spanwise coordinate z, where at the wing root 1904, z=0. The scale model wing tested in example 1 having the configuration shown in FIG. 19 was 0.3 m long from the root 1904 to the outboard tip 1903, and thus, in the scale model, z=0.3 at the outboard tip 1903. On the main wing 1910, the chord varies linearly with z.

The transitioning section 1921 of the wingtip 1920 begins at z=89% of the total wing length and ends at z=92% of the total wing length and varies with z as an ellipse added to a constant. On the straight leading edge section of the wingtip 1920, the chord varies linearly with z. The exact chord variation with z on the scale model is as follows (subject to rounding errors):

$$c ( z ) = 0.1 \; 151 \cdot \{ \begin{matrix}1 m - \frac{100}{45} z , 0 \leq z < 0.267 m \\ 0.2802 m + 8.7 \sqrt{0.000225 {m}^{2} - {( z - 0.2633 m )}^{2}} \\ 4.369 m - 14.56 z , 0.2762 m \leq z \leq 0.3 m\end{matrix} , 0.267 m \leq z < 2.762 m$$

The trailing edge 1902 features a constant forward sweep of 10.86°. The leading edge 1901 on the main portion of the wing 1910 is swept at a constant angle of 3.659°. The straight portion of the leading edge 1901 of the wingtip 1920 is swept at a constant angle of 56.04°.

In some embodiments, a wingtip of the invention may feature spanwise camber while in other embodiments, the wingtip remains substantially within the plane of the main wing. In some embodiments, the leading edge in the transitioning area is curved over a span of at least 10% of the total span of the wingtip, or at least 15% of the wingtip, or at least 20% of the wingtip, or at least 25% of the wingtip.

In some embodiments, in addition to eliminating airflow curling around the wingtip to the upper surface of the wing, a wingtip of the invention may also be designed in accordance with other principles well known in the art to optimize performance according to other variables. For example, a wingtip of the invention may be optimized according to the operating purpose of the wing to which it is attached. A common operating purpose of a wing is to deliver lift with minimal drag. However, in some applications such as military airplanes, the purpose of the wing may be to deliver a high absolute lift regardless of drag, or to deliver desirable stall characteristics. The schematic design shown in FIG. 14 provides an example where the initial wingtip design is optimized to reduce interference drag, in addition to eliminating airflow curling around the wingtip. In this embodiment, the leading edge 1412 follows a rounded curve until reaching the trailing edge 1413. This means that there is no sharp transition from the leading edge of the main wing to the leading edge of the wingtip 1412. Avoiding sharp edges typically leads to reducing interference drag on wings. In some embodiments, a wingtip of the invention may also be configured to optimize cross-sectional area distributions and reduce wave drag resulting from supersonic and transonic flow velocities without departing from the scope of the invention. In some embodiments, a wingtip of the invention may be optimized to lower production costs, to allow for the invented wingtip to be built using a certain material, or to allow the invented wingtip to be manufactured and operated using existing infrastructure.

### EXAMPLES

### 1. Experimental Determination of Orientation of Local Flow Velocity Vector and the Angle θ at Specified Points

Three different wings based on the NACA 4412 airfoil were tested in a wind tunnel: (a) an elliptical wing, (b) a trapezoidal wing, and (c) a trapezoidal wing fitted with a wingtip of the invention. The test wings were half-span wings with a wingtip and a wing root that was connected to the wall of the wind tunnel. The wall acts as an aerodynamic mirror so that the full span aerodynamics are easily measured using a half-span model.

The three test wings were made to feature approximately equal surface areas and equal wingspans in order to operate at equal mean Reynolds numbers and in order to feature equal aspect ratios so that any differences in operating characteristics are only due to the geometric shape of the wings. The wings were designed using Maplesoft Maple as a CAD tool in which the surfaces of the wings were parametrically designed. Then, the design was exported and sliced using CraftWare to a 3D print ready file and printed in a CraftBot XL 3D printer. The wings were designed with various cylindrical holes throughout the span of the wing in order to balance and reinforce the wing. The 3D printer's labelled accuracy is 50 μm, and the width of the nozzle head is 0.4 mm. This means that in the areas where the wings are more than 0.4 mm thick, the accuracy is very high. However, in the areas where the wing should be less than 0.4 mm thick, the shape is not accurately printed according to the design. However, this is only a problem very close to the trailing edges of the wings, and the total area of the affected area is so small that the error due to this inaccuracy has been disregarded.

After 3D printing, the wings were sanded using 600 grit sanding paper and painted blank white in order to improve and unify the surface finishes of the three wings. The cylindrical holes were then filled with sand for balancing purposes and a mix of carbon fiber and spring steel for reinforcement purposes. The reinforcement part was extended beyond the root of the wing in order to connect the wing to the wind tunnel. At the root of the wing, an end plate was mounted using epoxy in order to prevent air from leaking around the root of the wing. This end plate had rounded corners and measured 12 cm in the X-direction and 10 cm in the Y-direction.

| Wing | Elliptic | Trapezoid | With Swift Wingtip |
|---|---|---|---|
| Wing planform area | 0.02250 m² | 0.02259 m² | 0.02244 m² |
| Length (half span) | 0.300 m | 0.3008 m | 0.2985 m |
| Aspect ratio | 8 | 8.01 | 7.94 |
| Mean chord | 0.075 m | | |
| Root chord | 0.096 m | 0.113 m | 0.115 m |
| Airfoil | NACA 4412 | | |
| Root Reynolds | 3.80 · 10⁵ | 4.48 · 10⁵ | 4.59 · 10⁵ |
| number, 50 m/s | | | |
| Mean Reynolds | 2.99 · 10⁵ | | |
| number, 50 m/s | | | |
| Primary | Carbon fiber and spring | Carbon fiber and spring | Carbon fiber and spring |
| reinforcement | steel at 25% chord, | steel at 25% chord, | steel at 25% chord, |
| | 25 cm depth. | 23.3 cm depth. | 25 cm depth. |
| Secondary | N/A | ∅3 mm carbon fiber rod | N/A |
| reinforcement | | starting at 59% chord at | |
| | | root and ends at circa | |
| | | 25% chord, 27.3 cm | |
| | | depth. | |
| Ballast 3 | ∅4 mm sand filling 6% | ∅4 mm sand filling 6% | ∅4 mm sand filling 5% |
| | chord, 23.3 cm depth | chord, 21 cm depth | chord, 21.1 cm depth |

The specifications of the wings are as listed below:

To measure the direction of the local flow at specified locations, small strings were attached to the wing using thin tape at selected locations just below the leading edge at the tip of the wing. The direction in which the strings point at the point at which they are released from the tape is equal to the direction of the local flow velocity, ν at that point. FIG. 7 shows this measurement under conditions of airflow 50 m/s, dynamic pressure 1550 Pa at an angle of attack of 6° for the trapezoidal wing fitted with a wingtip of the invention (c) for two specified points corresponding to locations at 10% of the local chord aft from the leading edge (front) and at 15% of the local chord aft from the leading edge (rear). Similar results were observed at an angle of attack of 2°. The angle θ formed between the direction of the local flow velocity vector and a directed line segment dS extended in the aft direction from S, the curve followed by the leading edge, where θ is measured in the outboard rotational direction from ν to dS, was 27° (front) and 22° (rear). FIG. 20 shows this measurement for the trapezoidal wing (b) for one specified point corresponding to a location at 37% of the local chord aft from the leading edge. The angle θ measured as described above in this case was 341° The measurement can be conducted in this wind tunnel using each of the same wings, where for (a) for straight portions of any swept portions of the leading edge, for each section having a different sweep angle, at three points corresponding to a foremost point, a rearmost point, and a point equidistant between the two; (b) for curved portions of any swept portions of the leading edge, at at least three points corresponding to the rearmost part of the curve, and either one point equidistant between the two or, if applicable, one point for every 5° of curvature between; (c) except that in the particular case of the rearmost point on the leading edge, closest to the trailing edge, whether located on a straight or curved section, the measurement is made at a position that is forward from the point at which the leading edge meets the trailing edge by a distance corresponding to 1% of the local chord at the point at which the wingtip connects to the main wing, wherein in the case of rear swept portions of the wingtip's leading edge, the directed line segment dS is extended in the aft direction, and wherein in the case of forward swept portions of the wingtip's leading edge, the directed line segment is extended in the forward direction, over the range of angle of attack from −5 to 15° and/or over the range of dynamic pressure from 0 to 1590 Pa.

### 2. Experimental Determination of Trailing Vortex Velocity

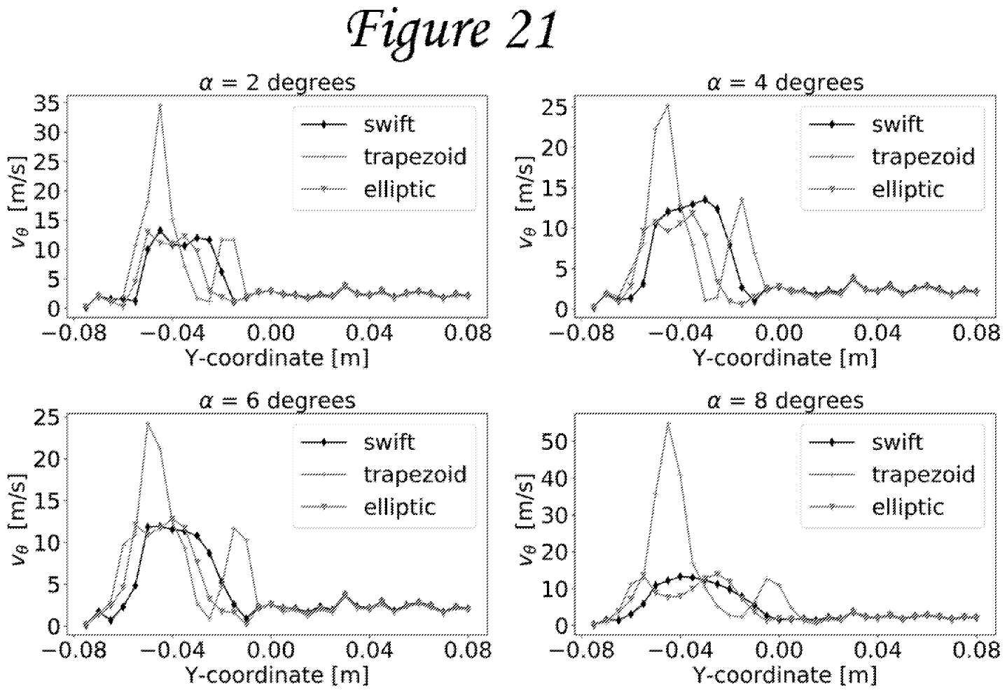

The velocity of trailing vortex flow was determined in a wind tunnel at airflow 50 m/s, dynamic pressure 1550 Pa, at 32 pressure stations located around 0.25 m aft of the wingtip for each of the test wings referred to in Example 1. The tested wingtip of the invention is hereafter referred to as a swift wingtip. The trailing vortex velocity was measured using a series of 32 pitot tubes that measure the pressure of the airflow. Using Bernoulli's principle, the velocity of the flow can be calculated using these measurements of pressure. Knowing that the velocity in the X direction is very close to the freestream velocity of 50 m/s, the velocity induced by the vortex can be determined using simple geometric calculations. These pitot tubes were mounted on a line extending in the Y-direction relative to the wing. Defining the point (0,0,0) as the outboard end of the trailing edge, the three-dimensional location of one of the pitot tubes is (0.25, Y, 0), where Y is the Y-coordinate of that pitot tube. FIG. 21 shows the distribution of the trailing vortex velocities for each of the three wings at angles of attack from 2° to 8° in increments of 2°. As shown, the wing equipped with a swift wingtip had greatly reduced trailing vortex velocity relative to a trapezoidal wing and performed approximately equivalently with the elliptical wing.

The embodiments and examples described herein are exemplative only and not intended to limit the scope of the invention as defined by the claims.

1. A wingtip having a leading edge and a trailing edge and being associated with a main wing characterized in that:
its' leading edge sweeps back from the leading edge of the main wing until it reaches its' trailing edge, and
its' leading edge follows a curve, S, the contour of which is configured such that, for the range of angle of attack between 0° and 2°, and for the range of dynamic pressure between 10 kPa to 12 kPa, the local flow velocity vector, ν, at 10% of the local chord aft of the leading edge forms an angle θ with a directed line segment dS extended from S, which angle is greater than 0° and less than 180°, where θ is measured in the outboard rotational direction from ν to dS, at each of the following points: (a) For straight portions of any swept portions of the leading edge, for each section having a different sweep angle, at three points corresponding to a foremost point, a rearmost point, and a point equidistant between the two; (b) for curved portions of any swept portions of the leading edge, at at least three points corresponding to the rearmost part of the curve, and either one point equidistant between the two or, if applicable, one point for every 5° of curvature between; (c) except that in the particular case of the rearmost point on the leading edge, closest to the trailing edge, whether located on a straight or curved section, the measurement is made at a position that is forward from the point at which the leading edge meets the trailing edge by a distance corresponding to 1% of the local chord at the point at which the wingtip connects to the main wing,
wherein in the case of rear swept portions of the wingtip's leading edge, the directed line segment dS is extended in the aft direction, and wherein in the case of forward swept portions of the wingtip's leading edge, the directed line segment is extended in the forward direction.

2. The wingtip of claim 1 which features a transition area that includes a curve that forms a smooth transition from the leading edge of the main wing to the leading edge of the wingtip.

3. The wingtip of claim 2 wherein the transition area is elliptical.

4. The wingtip of claim 2 in which the transition area is curved over a span that is at least 25% of the span from the point of attachment at the main wing to the point where the wingtip's leading edge meets its' trailing edge.

5. The wingtip of claim 1 characterized in that it has a constant, cambered, not flat, cross-sectional airfoil.

6. The wingtip of claim 1 characterized in that it has a constant thickness as a percentage of chord length between 8 and 15%.

7. The wingtip of claim 1 characterized in that it has a rounded leading edge in which the leading edge is not tapered to a point.
